(19) United States
(12) Patent Application Publication
(10) Pub. No.: US 2026/0331908 A1
(43) Pub. Date: Oct. 22, 2026

(54) SYSTEM AND METHOD FOR DIVERTING POWER OSCILLATIONS TO AN ENERGY BUFFER AFTER A GRID EVENT

(71) Applicant: General Electric Renovables España, S.L., Barcelona (ES)

(72) Inventors: Dustin Howard, Brookhaven, GA (US); Fernando Arturo Ramirez Sanchez, Salem, VA (US); Alfredo Sebastian Achilles, Niskayuna, NY (US)

(21) Appl. No.: 19/114,841

(22) PCT Filed: Sep. 26, 2022
(86) PCT No.: PCT/US2022/044676

§ 371 Date: Mar. 25, 2025

(51) Int. Cl. H02H 9/04; F03D 7/02; H02J 3/0014; H02J 3/38; H02J 101/28

(52) U.S. Cl. CPC H02H 9/042; F03D 7/0244; F03D 7/0284; H02J 3/0014; H02J 3/38; F05D 2270/053; H02J 2101/28

(57) ABSTRACT

A method for controlling a power generating asset connected to an electrical grid includes receiving, via a controller, a grid power target associated with an operating power level before one or more grid events occur in the electrical grid. The method also includes, during recovery from the one or more grid events, implementing, via the controller, a power diverter function. The power diverter function includes computing an expected grid power from at least one of the grid power target and a grid power limit, computing a power deviation between a power associated with the drivetrain and an expected grid power, and diverting at least a portion of the power deviation to an energy buffer to prevent the portion of the power deviation from reaching the electrical grid.

### RELATED APPLICATION

The present application claims priority to PCT Application No. PCT/US2022/044676, filed Sep. 26, 2022, which is incorporated by reference herein in its entirety.

### FIELD

The present disclosure relates in general to power generation, and more particularly to systems and methods for diverting power oscillations to a dynamic brake of a power generating asset after a grid event.

### BACKGROUND

Power generating assets may take a variety of forms and rely on renewable and/or nonrenewable sources of energy. Those power generating assets relying on renewable sources of energy may generally be considered one of the cleanest, most environmentally friendly energy sources presently available. For example, wind turbines have gained increased attention in this regard. A modern wind turbine typically includes a tower, a generator, a gearbox, a nacelle, and one or more rotor blades. The nacelle includes a rotor coupled to the gearbox and to the generator. The rotor and the gearbox are mounted on a bedplate support frame located within the nacelle. The rotor blades capture kinetic energy of wind using known airfoil principles. The rotor blades transmit the kinetic energy in the form of rotational energy so as to turn a shaft coupling the rotor blades to the gearbox, or if the gearbox is not used, directly to the generator. The generator then converts the mechanical energy to electrical energy and the electrical energy may be transmitted to a converter and/or a transformer housed within the tower and subsequently deployed to a utility grid. Modern wind power generation systems typically take the form of a wind farm having multiple wind turbine generators that are operable to supply power to a transmission system providing power to an electrical grid.

Wind turbines can be distinguished in two types: fixed speed and variable speed turbines. Conventionally, variable speed wind turbines are controlled as current sources connected to an electrical grid. In other words, the variable speed wind turbines rely on a grid frequency detected by a phase locked loop (PLL) as a reference and inject a specified amount of current into the grid. The conventional current source control of the wind turbines is based on the assumptions that the grid voltage waveforms are fundamental voltage waveforms with fixed frequency and magnitude and that the penetration of wind power into the grid is low enough so as to not cause disturbances to the grid voltage magnitude and frequency. Thus, the wind turbines simply inject the specified current into the grid based on the fundamental voltage waveforms.

Grid faults, such as low-voltage ride through (LVRT) and/or zero-voltage ride through (ZVRT) events, produce large transient torques in the mechanical drive train of the wind turbine power system. These torque events can reach large magnitudes that can damage the gearbox. Accordingly, existing drivetrain designs rely on a drive train damper (DTD) for mechanical stability. The DTD produces oscillations in grid power after fault clearing which can cause non-compliance in either power overshoots or damping and cause voltage stability issues in very weak grids. In addition, more aggressive DTD gains to reduce mechanical loading can increase a likelihood for power oscillation non-compliance.

In view of the foregoing, the art is continuously seeking new and improved systems and methods for diverting power oscillations to an energy buffer of a power generating asset after a grid event.

### BRIEF DESCRIPTION

Aspects and advantages of the invention will be set forth in part in the following description, or may be obvious from the description, or may be learned through practice of the invention.

In an aspect, the present disclosure is directed to a method for controlling a power generating asset connected to an electrical grid. The power generating asset has a power converter and a drivetrain with, at least, a generator. The method includes receiving, via a controller, a grid power target associated with an operating power level before one or more grid events occur in the electrical grid. During recovery from the one or more grid events, the method includes implementing, via the controller, a power diverter function. The power diverter function includes computing an expected grid power from at least one of the grid power target and a grid power limit, computing a power deviation between a power associated with the drivetrain and an expected grid power, and diverting at least a portion of the power deviation to an energy buffer to prevent the portion of the power deviation from reaching the electrical grid.

In another aspect, the present disclosure is directed to a power generating asset connected to an electrical grid. The power generating asset includes a generator, a power converter coupled to the generator, and a controller having at least one processor configured to perform a plurality of operations. The plurality of operations includes receiving an indication of one or more grid events occurring in the electrical grid, and during recovery from the one or more grid events, implementing a power diverter function. The power diverter function includes computing an expected grid power from at least one of the grid power target and a grid power limit, computing a power deviation between a power associated with the drivetrain and an expected grid power, and diverting at least a portion of the power deviation to an energy buffer to prevent the portion of the power deviation from reaching the electrical grid.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an embodiment of a power generating asset configured as a wind turbine power system according to the present disclosure;

FIG. 2 illustrates a schematic diagram of an embodiment of an electrical system for use with a power generating asset configured as a wind turbine power system according to the present disclosure;

FIG. 3 illustrates a block diagram of an embodiment of a controller for use with a power generating asset according to the present disclosure;

FIG. 4 illustrates a simplified, schematic diagram of the electrical system of FIG. 2, particularly illustrating power flow during normal operations and during one or more grid events according to the present disclosure;

FIG. 5 illustrates a flow diagram of one embodiment of a method for controlling a power generating asset connected to an electrical grid according to the present disclosure;

FIG. 6 illustrates a schematic diagram of an embodiment of a power softening function according to the present disclosure;

FIG. 7 illustrates a schematic diagram of integration of an energy buffer power command from a power softening function into existing controls of the power generating asset according to the present disclosure; and

FIG. 8 illustrates a schematic diagram of integration of a power command from a power softening function into existing controls of the power generating asset according to the present disclosure.

FIG. 9 illustrates a flow diagram of one embodiment of a method for controlling a power generating asset connected to an electrical grid according to the present disclosure;

FIG. 10 illustrates a schematic diagram of an embodiment of a power diverter function according to the present disclosure; and

FIG. 11 illustrates a schematic diagram of integration of a dynamic brake power command from a power diverter function into existing controls of the power generating asset according to the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Grid events, such as low-voltage ride through (LVRT) and/or zero-voltage ride through (ZVRT) events, produce large transient torques in the mechanical drive train of a wind turbine power system that can damage the gearbox. Accordingly, existing drivetrain designs for wind turbine power systems typically rely on a slip coupling to meet LVRT/ZVRT requirements. In particular, the slip coupling may be installed for protection of the gearbox. However, the slip coupling can wear out quickly and can be expensive to replace. Moreover, existing grid codes require power generating assets to recover active power to pre-fault power levels following grid faults and to avoid excessive deviations from the pre-fault power levels. Certain control functions used to manage mechanical loading on the wind turbine may cause deviations (from pre-grid-disturbance) in power during recovery from a grid event. Such deviations can lead to non-compliance with the different grid codes or increase voltage stability risks if the power deviations are excessively large and the grid is weak.

Accordingly, the present disclosure is directed to systems and methods for controlling a power generating asset, such as a wind turbine, connected to an electrical grid that simultaneously commands a non-zero power command (causing active power to flow in the generator stator) and an energy buffer, such as a dynamic brake, to operate. As such, converter controls have the capability to reduce power changes on the drivetrain due to grid events by either dissipating or storing power in the energy buffer during a grid fault, thereby providing an increased margin on the drivetrain components for loads. The power command can be used to increase generator torque when the grid power is being constrained during a fault, whereas a coordinated power command can be sent to the energy buffer to provide power buffering for the extra power generated during the grid event. Such buffering may include storing and/or dissipating the generated power. Thus, systems and methods of the present disclosure effectively circulate active power from the generator stator through the line side converter of the power converter to provide active power within grid constraints to the grid during grid events.

In another embodiment, the present disclosure is directed to systems and methods for controlling a power generating asset, such as a wind turbine, connected to an electrical grid that utilizes a power diverter function in the converter controller to divert power deviations after a grid event by dissipating or storing power in the energy buffer. In such embodiments, the diverted power does not reach the grid, effectively decreasing deviations in grid power without impacting drivetrain torque/power. Moreover, in an embodiment, the power diverter function is designed to reduce deviations of grid active power after a grid event for a short period of time following grid faults.

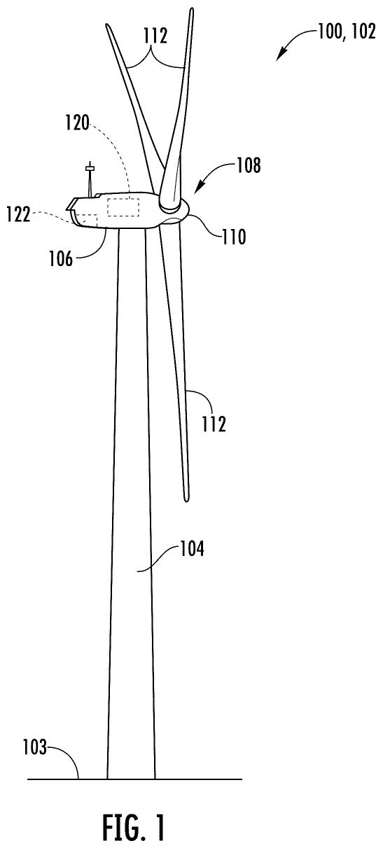

Referring now to the drawings, FIG. 1 illustrates a perspective view of one embodiment of a power generating asset 100 according to the present disclosure. As shown, the power generating asset 100 may be configured as a wind turbine 102. In an additional embodiment, the power generating asset 100 may, for example, be configured as a hydroelectric plant, a fossil fuel generator, and/or a hybrid power generating asset.

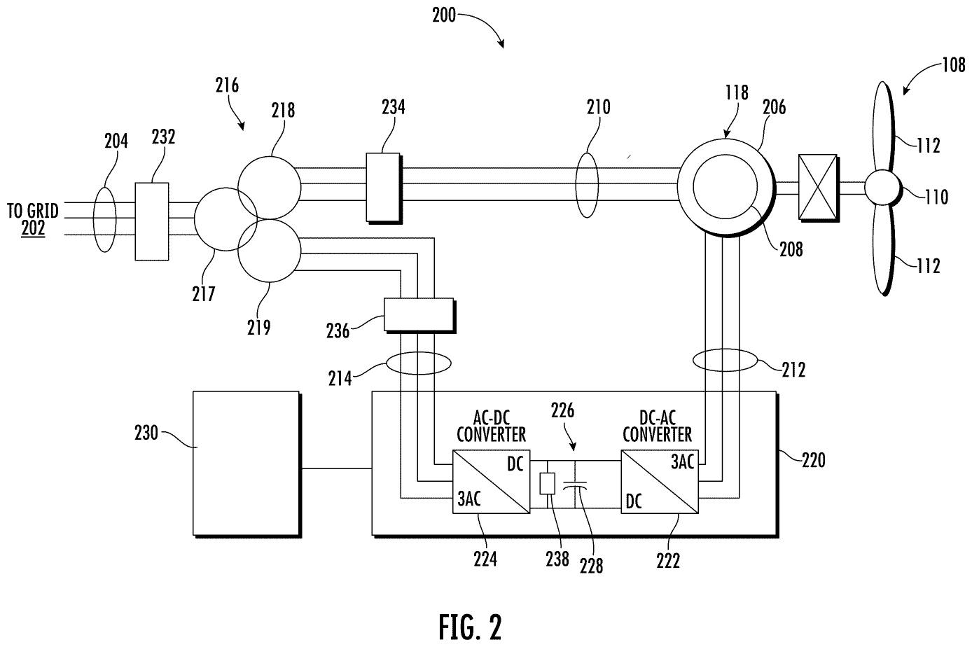

When configured as a wind turbine 102, the power generating asset 100 may generally include a tower 104 extending from a support surface 103, a nacelle 106 mounted on the tower 104, and a rotor 108 coupled to the nacelle 106. The rotor 108 includes a rotatable hub 110 and at least one rotor blade 112 coupled to and extending outwardly from the hub 110. For example, in the illustrated embodiment, the rotor 108 includes three rotor blades 112. However, in an alternative embodiment, the rotor 108 may include more or less than three rotor blades 112. Each rotor blade 112 may be spaced about the hub 110 to facilitate rotating the rotor 108 to enable kinetic energy to be transferred from the wind into usable mechanical energy, and subsequently, electrical energy. For instance, the hub 110 may be rotatably coupled to an electric generator 118 (FIG. 2) of an electrical system 200 (FIG. 2) positioned within the nacelle 106 to permit electrical energy to be produced.

The wind turbine 102 may also include a controller 120 centralized within the nacelle 106. However, in other embodiments, the controller 120 may be located within any other component of the wind turbine 102 or at a location outside the wind turbine 102. Further, the controller 120 may be communicatively coupled to any number of the components of the wind turbine 102 in order to control the components. As such, the controller 120 may include a computer or other suitable processing unit. Thus, in several embodiments, the controller 120 may include suitable computer-readable instructions that, when implemented, configure the controller 120 to perform various different functions, such as receiving, transmitting and/or executing wind turbine control signals.

Furthermore, as depicted in FIG. 1, in an embodiment, the power generating asset 100 may include at least one operational sensor 122. The operational sensor(s) 122 may be configured to detect a performance of the power generating asset 100, e.g., in response to the environmental condition. In an embodiment, the operational sensor(s) 122 may be configured to monitor a plurality of electrical conditions, such as slip, stator voltage and current, rotor voltage and current, line-side voltage and current, DC-link charge and/or any other electrical condition of the power generating asset 100.

It should also be appreciated that, as used herein, the term “monitor” and variations thereof indicates that the various sensors of the power generating asset 100 may be configured to provide a direct measurement of the parameters being monitored or an indirect measurement of such parameters. Thus, the sensor(s) 122 described herein may, for example, be used to generate signals relating to the parameter being monitored, which can then be utilized by the controller 120 to determine a condition or response of the power generating asset 100.

Referring now to FIG. 2, wherein an exemplary electrical system 200 of the power generating asset 100 is illustrated. As shown, the generator 118 may be coupled to the rotor 108 for producing electrical power from the rotational energy generated by the rotor 108. Accordingly, in an embodiment, the electrical system 200 may include various components for converting the kinetic energy of the rotor 108 into an electrical output in an acceptable form to an electrical grid 202 via grid bus 204. For example, in an embodiment, the generator 118 may be a double-fed induction generator (DFIG) having a stator 206 and a generator rotor 208. The generator 118 may be coupled to a stator bus 210 and a power converter 220 via a rotor bus 212. In such a configuration, the stator bus 210 may provide an output multiphase power (e.g., three-phase power) from a stator of the generator 118, and the rotor bus 212 may provide an output multiphase power (e.g., three-phase power) of the generator rotor 208 of the generator 118. Additionally, the generator 118 may be coupled via the rotor bus 212 to a rotor side converter 222. The rotor side converter 222 may be coupled to a line-side converter 224 which, in turn, may be coupled to a line-side bus 214.

In an embodiment, the rotor side converter 222 and the line-side converter 224 may be configured for normal operating mode in a three-phase, pulse width modulation (PWM) arrangement using insulated gate bipolar transistors (IGBTs) Other suitable switching devices may be used, such as insulated gate commuted thyristors, MOSFETs, bipolar transistors, silicone-controlled rectifiers, and/or other suitable switching devices. Furthermore, as shown, the rotor side converter 222 and the line-side converter 224 may be coupled via a DC link 226 across a DC link capacitor 228. In addition, as shown, the power converter 220 may include an energy buffer, such as a dynamic brake 238.

In an embodiment, the power converter 220 may be coupled to the controller 120 configured as a converter controller 230 to control the operation of the power converter 220. For example, the converter controller 202 may send control commands to the rotor side converter 222 and the line-side converter 224 to control the modulation of switching elements used in the power converter 220 to establish a desired generator torque setpoint and/or power output.

As further depicted in FIG. 2, the electrical system 200 may, in an embodiment, include a transformer 216 coupling the power generating asset of 100 to the electrical grid 202. The transformer 216 may, in an embodiment, be a three-winding transformer which includes a high voltage (e.g., greater than 12 KVAC) primary winding 217. The high voltage primary winding 217 may be coupled to the electrical grid 179. The transformer 216 may also include a medium voltage (e.g., 6 KVAC) secondary winding 218 coupled to the stator bus 210 and a low voltage (e.g., 575 VAC, 690 VAC, etc.) auxiliary winding 219 coupled to the line bus 214. It should be appreciated that the transformer 216 can be a three-winding transformer as depicted, or alternatively, may be a two-winding transformer having only the primary winding 217 and the secondary winding 218; may be a four-winding transformer having the primary winding 217, the secondary winding 218, the auxiliary winding 219, and an additional auxiliary winding; or may have any other suitable number of windings.

In an embodiment, the electrical system 200 may include various protective features (e.g., circuit breakers, fuses, contactors, and other devices) to control and/or protect the various components of the electrical system 200. For example, the electrical system 200 may, in an embodiment, include a grid circuit breaker 232, a stator bus circuit breaker 234, and/or a line bus circuit breaker 236. The circuit breaker(s) 232, 234, 236 of the electrical system 200 may connect or disconnect corresponding components of the electrical system 200 when a condition of the electrical system 200 approaches a threshold (e.g., a current threshold and/or an operational threshold) of the electrical system 200.

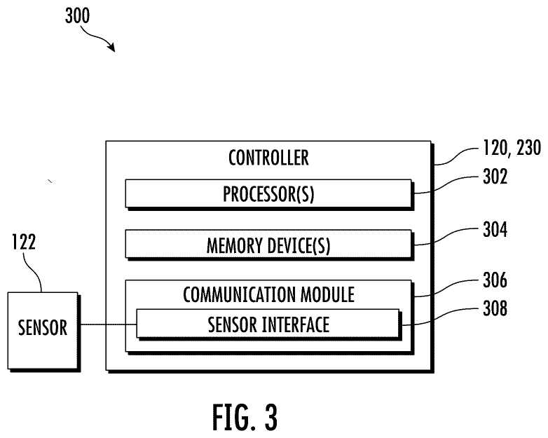

Referring now to FIG. 3, a block diagram of an embodiment of suitable components that may be included within a controller 300 of the power generating asset 100, such as the wind turbine 102, is illustrated. For example, as shown, the controller 300 may be the turbine controller 120 or the converter controller 230. Further, as shown, the controller 120 includes one or more processor(s) 302 and associated memory device(s) 304 configured to perform a variety of computer-implemented functions (e.g., performing the methods, steps, calculations and the like and storing relevant data as disclosed herein). Additionally, the controller 300, may also include a communications module 306 to facilitate communications between the controller 300, and the various components of the power generating asset 100. Further, the communications module 306 may include a sensor interface 308 (e.g., one or more analog-to-digital converters) to permit signals transmitted from the sensor(s) 122 to be converted into signals that can be understood and processed by the processors 302. It should be appreciated that the sensor(s) 122 may be communicatively coupled to the communications module 306 using any suitable means. For example, the sensor(s) 122 may be coupled to the sensor interface 308 via a wired connection. However, in other embodiments, the sensor(s) 122 may be coupled to the sensor interface 308 via a wireless connection, such as by using any suitable wireless communications protocol known in the art.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 304 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 304 may generally be configured to store suitable computer-readable instructions that, when implemented by the processor(s) 302, configure the controller 300 to perform various functions as described herein, as well as various other suitable computer-implemented functions.

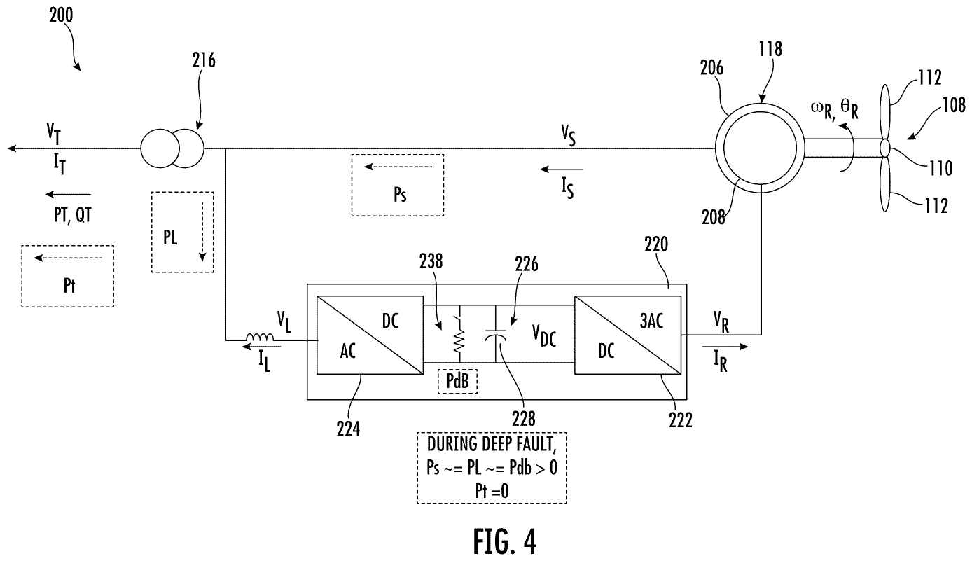

Referring now to FIG. 4, a simplified, schematic diagram of the electrical system 200 of FIG. 2 is illustrated, particularly illustrating power flow during normal operations and during one or more grid events according to the present disclosure. More specifically, as shown, the power flow during normal operations is represented by the solid arrows throughout the system 200, whereas the power flow during the grid event(s) is represented by the dotted arrows within the dotted boxes throughout the system 200. FIG. 4 further illustrates an embodiment of an energy buffer, which is the dynamic brake 238 between the rotor side converter 222 and the line-side converter 224. Further, as shown, the dynamic brake 238 is represented as a resistor. Moreover, as shown, the power flow at the output of the system 200 (i.e., Pt and PT in FIG. 4) reflects the grid power/net power output of the system 200. Further, in an embodiment, the generator power is equal to the electric torque on the generator 118 multiplied by the operating speed, which is reflected as power flow through the stator and rotor windings of the generator 118. Most of the generator power flows through the stator (i.e., Ps in FIG. 4) during normal and grid-fault conditions.

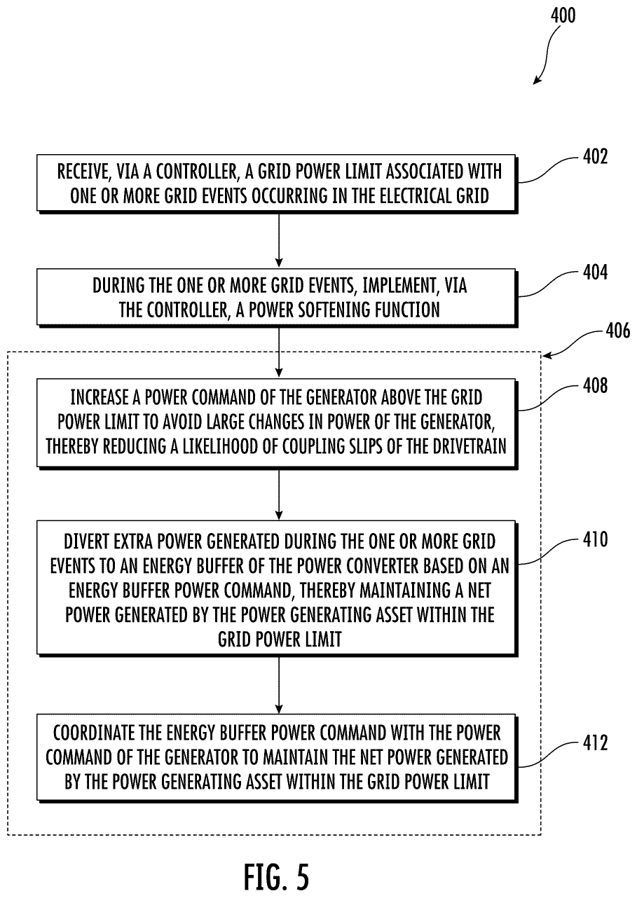

Referring now to FIG. 5, a flow diagram of one embodiment of a method 400 for controlling the power generating asset 100, particularly during a grid event, is presented. In particular embodiments, for example, the grid event may be a low-voltage ride through event (LVRT) or a zero-voltage ride through (ZVRT) event. In further embodiments, the grid event may be any event occurring in the grid that causes large changes in generator torque/power that lead to stresses on drivetrain components. The method 400 may be implemented using, for instance, the controller 300 of the present disclosure discussed above with references to FIGS. 2-4. FIG. 5 depicts steps performed in a particular order for purposes of illustration and discussion. Those of ordinary skill in the art, using the disclosures provided herein, will understand that various steps of the method 400, or any of the methods disclosed herein, may be adapted, modified, rearranged, performed simultaneously, or modified in various ways without deviating from the scope of the present disclosure.

As shown at (402), the method 400 may include receiving, via a controller, a grid power limit 502 (e.g., PwrLimGDPLPu) associated with one or more grid events occurring in the electrical grid. For example, in an embodiment, the method 400 may include computing the grid power limit as a function of a voltage feedback, a phase locked loop (PLL) error signal, or similar. By dynamically reducing the grid active power limit during grid events, together with prioritization of voltage support, the electrical stability of the grid may be improved. However, this prioritization of grid stability can have significant impact on the drivetrain components due to the large change in power/torque associated with the grid power limit activating. To help reduce this adverse effect on the large power/torque change on the drivetrain components, as shown at (404), the method 400 may include implementing, via the controller 300, a power softening function 406 during the grid event(s). For example, as shown (408), the power softening function 406 includes increasing a power command of the generator above the grid power limit to avoid large changes in power of the generator, thereby reducing a likelihood of coupling slips of the drivetrain.

Further, as shown at (410), the power softening function 406 includes diverting extra power generated during the grid event(s) to an energy buffer based on an energy buffer power command. In particular embodiments, the power softening function 406 may include simultaneously increasing the power command of the generator and diverting the extra power generated during the grid event(s) to the energy buffer based on the energy buffer power command. In certain embodiments, for example, the energy buffer may include the dynamic brake 238 of the power converter 200, one or more ultracapacitors, or an energy storage device.

Moreover, as shown at (412), the power softening function 406 includes coordinating the energy buffer power command with the power command of the generator to maintain the net power generated by the power generating asset within the grid power limit. Thus, the power softening function 406 is configured to prevent a generator power output of the generator from dropping to zero during the grid event(s), thereby decreasing a change in drivetrain power caused by the grid event(s).

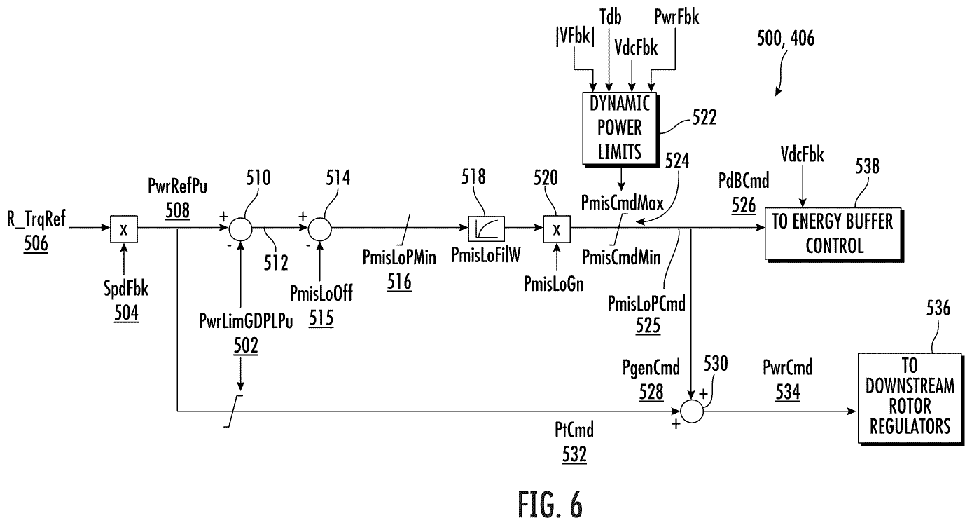

The method 400 of FIG. 5 can be better understood with reference to FIGS. 6-8. In particular, FIG. 6 illustrates a schematic diagram 500 of an embodiment of the power softening function 406 according to the present disclosure. As shown, the power softening function 406 receives a plurality of inputs. In particular embodiments, as shown, the plurality of inputs may include, for example, the grid power limit 502 (e.g., PwrLimGDPLPu), a speed feedback signal 504 (e.g., SpdFbk), a rotor torque reference 506 (R_TrqRef) of the wind turbine 102 (e.g., from turbine controller 120), a power reference of the wind turbine 102, or any other suitable input.

Thus, as shown, the power softening function 406 is configured to determine a grid power reference signal 508 as a function of the speed feedback signal 504 and the rotor torque reference 506. Furthermore, as shown, the power softening function 406 is configured to determine an error signal 512 using the plurality of inputs. More specifically, as shown at 510, the grid power reference signal 508 may be compared to the grid power limit 502 to determine the error signal 512, which is a difference between the grid power reference signal 508 and the grid power limit 502. During normal operations, the error signal 512 is negative since the grid power limit is above the operating power. However, during a grid fault, the error signal 512 increases to generate a plurality of outputs. In particular embodiments, for example, the error signal is used to generate the energy buffer power command 526 (e.g., PdBCmd) and a generator power output 528 (e.g., PgenCmd) described herein.

Referring still to FIG. 6, the power softening function 406 is further configured to process the error signal 512. For example, as shown, processing the error signal 512 may include comparing the error signal 512 to an offset 515 (e.g., PmisLoOff) via comparator 514, limiting the error signal 512 by applying a lower limit 516 (e.g., PmisLoPMin) to the error signal 512, and/or filtering the error signal 512 via a filter 518, such as a low pass filter. In such embodiments, for example, the offset 515 together with the lower limit 516 may assist with activating the power softening function 406 for more or less severe grid faults and for maintaining the power softening function 406 inactive during normal operating conditions. For example, the offset 515 may be set to a 0.3 PU (per unit) power and the lower limit 516 may be set to zero, which indicates the error signal 512 must be greater than 0.3 PU before the power softening function 406 becomes activated. Similarly, since the error signal 512 is negative during normal operating conditions, the lower limit 516 of zero will keep the power softening function 406 disabled during these conditions. Alternative settings can also be chosen to activate the power softening function 406 at smaller or larger power error settings.

In particular embodiments, as shown, the power softening function 406 is further configured to applying a gain 520 (e.g., PmisLoGn) to the error signal 512. Furthermore, as shown, the power softening function 406 is configured to apply one or more dynamic power limits 522 to the error signal 512. In such embodiments, for example, the dynamic power limit(s) 522 of the power softening function 406 may be calculated to avoid excessive power/energy consumption, to avoid overheating certain components, and/or to avoid a collapse in DC voltage. For example, in an embodiment, a dynamic power limit may be computed based on a magnitude of the voltage feedback (e.g., VFbk) multiplied by the maximum current limit of the line side converter 224, thereby constraining the power softening function 406 more as voltage drops lower to constraint currents within the limitations of the converter ratings. In other embodiments, the power limits may be fixed values. In other embodiments, the dynamic power limit(s) 522 may designed to constrain the power softening function 406 if certain feedbacks exceed at least one of a temperature limit, a power demand limit, a power consumption limit, a trip limit, a reverse power limit, a load limit, a voltage limit, or any other suitable limit. Thus, as shown, the dynamic limit(s) 522 can be applied to the error signal 512 via limiter 524 having maximum and minimum limits (e.g., PmisCmdMax and PmisCmdMin). Further, as shown, an output of the limit is a power command 525 (e.g., PmisLoPCmd). Accordingly, the power command 525 can be used to generate outputs of the power softening function 406, which are the energy buffer power command 526 (e.g., PdBCmd) and the generator power output 528 (e.g., PgenCmd).

Moreover, as shown at 530, the power softening function 406 is configured to sum the generator power command 528 with a grid power reference 532 (e.g., PtCmd) to generate a power command 534 (e.g., PwrCmd) that can be sent to downstream rotor regulators 536 to increase generator torque when the grid power is being constrained, e.g., during a grid fault. In addition, as shown at 538, the energy buffer power command 526 can be sent to energy buffer control. In such embodiments, the energy buffer power command 526 is configured to provide a power sink for the extra power generated during the grid event. In additional embodiments, the power softening function 406 is configured to coordinate the energy buffer power command 526 with the power command of the generator to maintain the net power generated by the power generating asset within the grid power limit.

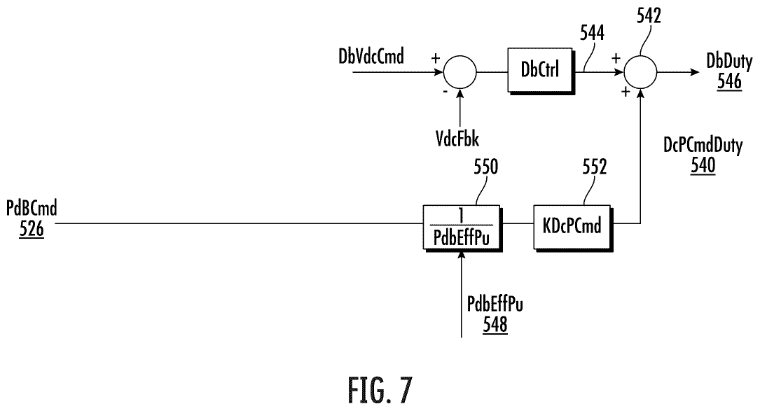

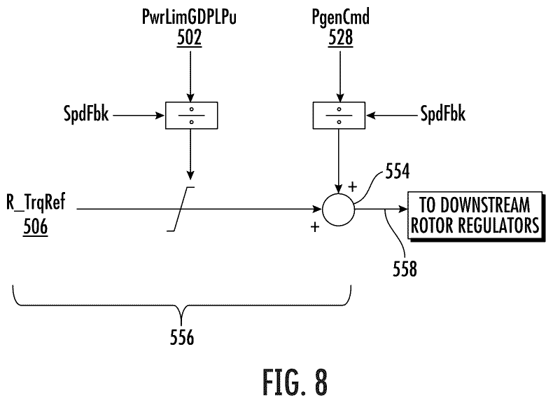

Referring now to FIGS. 7 and 8, schematic diagrams of integration of the outputs (e.g., the energy buffer power command 526 and the power command 534) from the power softening function 406 into existing controls of the power generating asset 100 according to the present disclosure are illustrated. In particular, FIG. 7 illustrates a schematic diagram of integration of the energy buffer power command 526 from the power softening function 406 into dynamic brake existing controls of the power generating asset 100 according to the present disclosure; whereas FIG. 8illustrates a schematic diagram of integration of the power command 534 (e.g., PwrCmd) from the power softening function 406 into existing torque controls of the power generating asset 100 according to the present disclosure.

Referring particularly to FIG. 7, the power softening function 406 is configured to request the energy buffer power command 526. In such embodiments, the energy buffer power command 526 can be used to calculate a duty cycle command 540 (e.g., DcPCmdDuty) for the dynamic brake 238 (FIGS. 2 and 4). Thus, as shown at 542, the duty cycle command 540 can be summed with existing duty commands 544 from DB control to obtain a dynamic brake duty cycle signal 546 for the dynamic brake 238. In particular embodiments, the energy buffer power command 526 may be processed before being combined with the existing duty commands 544. For example, as shown at 550, a power dissipation capability signal 548 may be applied to the energy buffer power command 526 for determining a power command that is normalized on the power dissipation capability of the dynamic brake 238. Furthermore, as shown at 552, a gain may be applied to the energy buffer power command 526 before calculating the duty cycle command 540.

Referring particularly to FIG. 8, an alternative implementation of the generator power output 528 (e.g., PgenCmd) along a torque control may be used. For example, the generator power output 528 may be divided by a speed feedback signal (e.g., SpdFbk) to obtain a generator torque command. Thus, as shown at 554, the generator torque command may be summed to a torque command path 556 of existing controls during the grid event. Accordingly, an output 558 of the summator 554 can be used in downstream rotor regulators to regulate the generator torque.

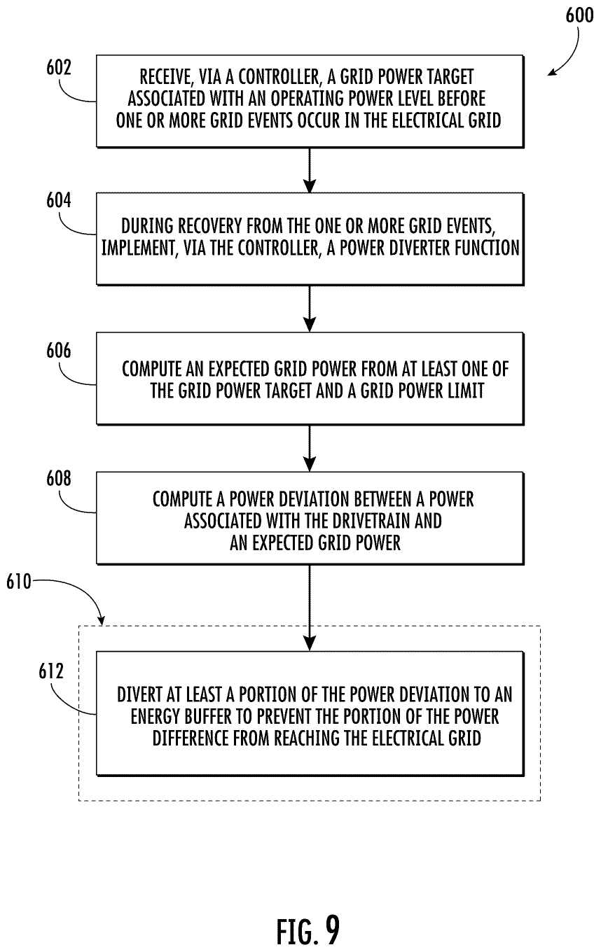

Referring now to FIG. 9, a flow diagram of one embodiment of a method 600 for controlling the power generating asset 100, e.g., during recovery from the one or more grid events, is presented. The method 600 may be implemented using, for instance, the controller 300 of the present disclosure discussed above with references to FIGS. 1-4 and 6-8. FIG. 9 depicts steps performed in a particular order for purposes of illustration and discussion. Those of ordinary skill in the art, using the disclosures provided herein, will understand that various steps of the method 600, or any of the methods disclosed herein, may be adapted, modified, rearranged, performed simultaneously, or modified in various ways without deviating from the scope of the present disclosure.

As shown at (602), the method 600 includes receiving, via a controller, a grid power target associated with an operating power level before one or more grid events occur in the electrical grid. During recovery from the grid event(s), as shown at (604), the method 600 includes implementing, via the controller, a power diverter function 606. In particular, as shown at (608), the power diverter function 606 includes, at least, computing an expected grid power from at least one of the grid power target and a grid power limit. As shown at (610), the power diverter function 606 includes computing a power deviation between a power associated with the drivetrain and an expected grid power. Further, as shown at (612), the power diverter function 606 includes diverting at least a portion of the power deviation to an energy buffer to prevent the portion of the power deviation from reaching the electrical grid.

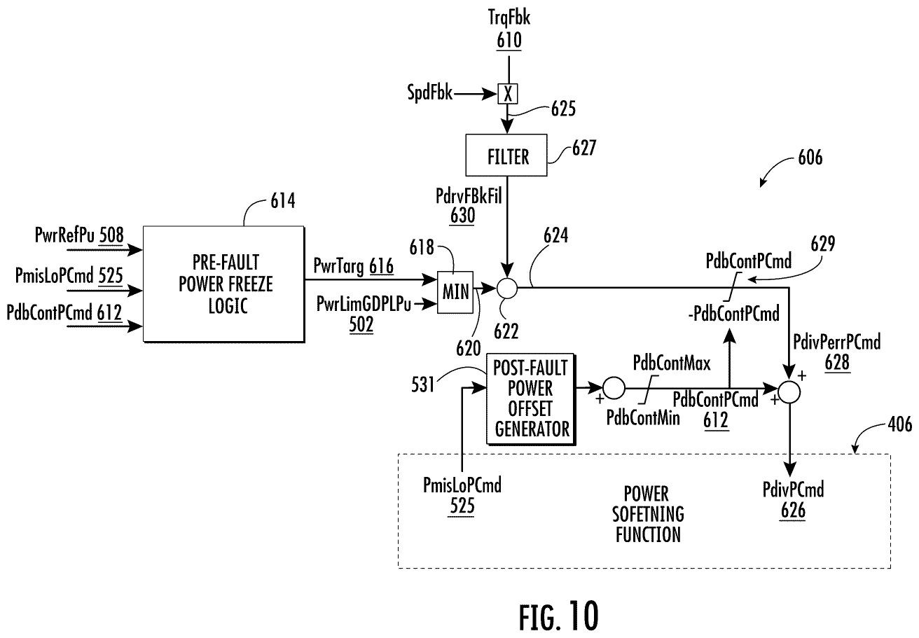

The method 600 of FIG. 9 can be better understood with reference to FIG. 10. In particular, FIG. 10 illustrates a schematic diagram of an embodiment of the power diverter function 606 according to the present disclosure. Accordingly, as shown, the power diverter function 606 is configured to receive a grid power target associated with an operating power level before one or more grid events occur in the electrical grid. This grid power target may be received from a sample and hold function on a grid power reference. As used herein, a sample and hold function generally refers to an analog device that samples the voltage of a continuously varying analog signal and holds its value at a constant level for a specified minimum period of time. For example, if a signal indicative of a grid fault indicates the present of the grid fault (e.g., PmisLoPCmd becoming non-zero), the grid power reference may be sampled (or frozen) and stored for a certain period of time until after the fault is over. During this period of time, this stored version of the grid power reference can serve as the grid power target of the power diverter function 406. More specifically, as shown, the power diverter function 606 is configured to receive a grid power limit 502 (e.g., PwrLimGDPLPu) of the controller of the power generating asset. Furthermore, in an embodiment, still further inputs of the power diverter function 606 may include a rotor torque reference, a speed feedback signal, the grid power reference signal 508 (e.g., PwrRefPu), the power command 525 (e.g., PmisLoPCmd), a power offset signal 612 (e.g., PdbContPCmd) from the power softening function 406, and/or a torque feedback signal 610 (e.g., TrqFbk).

Thus, in an embodiment, as shown at 614, the power diverter function 606 may include pre-fault power freeze logic that receives the inputs and freezes a pre-fault power 616 (e.g., PwrTarg). Accordingly, as shown at 618, the power diverter function 606 is configured to determine a minimum value 620 between the pre-fault power reference 616 and the grid power limit 502 (e.g., PwrLimGDPLPu). The minimum of the grid power limit and the pre-fault power reference reflects the expected grid power to be injected by the generator 118 during the recovery from the grid event (e.g., from the time the grid event ends to about 1-10 seconds after the grid event ends).

As such, the power diverter function 606 is further configured to compute a power deviation 624 between a power associated with the drivetrain and an expected grid power and divert at least a portion of the power deviation 624 to an energy buffer, such as the dynamic brake 238, to prevent the portion of the power deviation 624 from reaching the electrical grid. In particular, as shown, the power diverter function 606 is configured to determine the power deviation 624 using the plurality of inputs. For example, as shown in FIG. 10, as shown at 622, the power diverter function 606 is configured to determine the power deviation 624 between pre-fault grid power and post-fault drivetrain power together with a power offset signal 612 to allow for positive and negative changes in dynamic brake power around the power offset signal 612. The power deviation 624 can then be used by the power diverter function 606 to generate an output 626. In particular, as shown, the output 626 may include a power diverter command 626 (e.g., PdivPCmd) for the energy buffer. In certain embodiments, rather than the drivetrain power being measured directly, the drivetrain power can be calculated based on multiplying the generator electric (or air-gap torque) (e.g., TrqFbk 610 in FIG. 10) with the measured speed feedback. Moreover, in an embodiment, the generator electric torque may not be measured directly, but can be estimated from electrical feedbacks of voltage and currents on the stator and rotor as well as electrical parameters of the generator 118. These feedbacks and parameters may be combined using well known electrical relationships for electrical machines to obtain an estimate of the generator electric torque.

Still referring to FIG. 10, the power diverter command 626 for the energy buffer may include the power offset signal 626 (e.g., PdbContPCmd) and a power command signal associated with the power deviation 628 (e.g., PdivPerrPCmd). In particular, as shown, the power command signal associated with the power deviation 628 generally refers to the power deviation 624 in which one or more limits 629 are applied. In such embodiments, the limits of the power command signal associated with the power deviation 628 may be proportional to the power offset signal 612, whereas the power offset signal 612 may be triggered by the presence of the grid event(s) (e.g., as determined by the power softening function 406). Thus, in an embodiment, the power offset signal 612 (e.g., PdbContPCmd) allows the power command associated with the power deviation signal 628 to increase and decrease the energy buffer power around the power offset signal 612.

Furthermore, the magnitude of the power offset signal 612 determines limits on the power command signal associated with the power deviation 628, which eventually decays to zero after a grid fault. As shown in FIG. 10, this may be achieved by a post-fault power offset generator 531 that includes a function designed to generate a temporary power offset during recovery of a grid event. For example, the post-fault power offset generator 531 may cause the power offset to increase at the end of a grid event, and slowly decrease the offset until a certain time duration after the grid event has ended (e.g., from about 1-10 seconds after the grid event ends). In an embodiment, this type of function can be achieved by a first order fast-up, slow-down filter.

In addition, as shown, the power command signal associated with the power deviation 628 may be determined based on the power deviation 624, which represents a difference between post-fault drivetrain power 625 and pre-fault grid power 616 (e.g., PwrTarg). In other embodiments, a washout filter may be applied to the power deviation signal to remove steady-state differences between the drivetrain power and expected grid power. Moreover, as shown, the post-fault drivetrain power 625 may be filtered via filter 627 to obtain filtered power signal 630 (e.g., PdrvFbkFil).

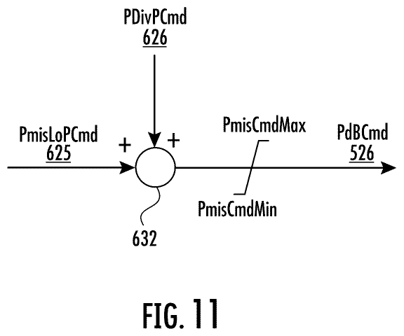

Referring now to FIG. 11, as shown at 632, the power diverter function 606 is configured to add the power diverter command 626 for the energy buffer, such as the dynamic brake 238, to the power command 525 (e.g., PmisLoPCmd) of the dynamic brake 238 from the power softening function 406. Thus, in an embodiment, the power diverter function 606 is configured to match the energy buffer power command with an opposite sign of the power deviation, thereby largely reducing or cancelling the amount of power deviation that appears in the grid power (or net power).

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Further aspects of the invention are provided by the subject matter of the following clauses:

A method for controlling a power generating asset connected to an electrical grid, the power generating asset having a power converter and a drivetrain with, at least, a generator, the method comprising: receiving, via a controller, a grid power target associated with an operating power level before one or more grid events occur in the electrical grid; during recovery from the one or more grid events, implementing, via the controller, a power diverter function, the power diverter function comprising: computing an expected grid power from at least one of the grid power target and a grid power limit; computing a power deviation between a power associated with the drivetrain and an expected grid power; and diverting at least a portion of the power deviation to an energy buffer to prevent the portion of the power deviation from reaching the electrical grid.

The method of any preceding clause, further comprising receiving the grid power target associated with the operating power level before the one or more grid events from a sample and hold function.

The method of any preceding clause, wherein diverting at least the portion of the power deviation to the energy buffer further comprises: receiving, via the power diverter function, a plurality of inputs; determining, via the power diverter function, the power deviation using the plurality of inputs; and generating, via the power diverter function, an output based on the power deviation, the output comprising a power diverter command for the energy buffer.

The method of any preceding clause, wherein the plurality of inputs comprises at least one of a torque reference, a speed feedback signal, a power reference, a power reference signal from the power softening function, the grid power limit, a power offset signal, a torque feedback signal, a voltage magnitude signal, or combinations thereof.

The method of any preceding clause, further comprising determining a power command signal associated only with the power deviation.

The method of any preceding clause, wherein generating the output based on the power deviation further comprises: combining the power command signal associated only with power deviation with a power offset signal to allow for positive and negative changes in energy buffer power around the power offset signal.

The method of any preceding clause, wherein the power diverter command for the energy buffer comprises the power offset signal and the power deviation, the power offset signal being triggered by the one or more grid events.

The method of any preceding clause, wherein a magnitude of the power offset signal determines limits on the power command signal associated only with the power deviation.

The method of any preceding clause, wherein the power diverter function further comprises adding the power diverter command for the energy buffer to an energy buffer power command of the energy buffer from the power softening function.

The method of any preceding clause, wherein the power diverter function further comprises determining the energy buffer power command for the energy buffer as a function of a torque command and a torque reference of the generator.

The method of any preceding clause, wherein the power diverter function further comprises matching the energy buffer power command with an opposite sign of the power deviation.

The method of any preceding clause, wherein the power generating asset is a wind turbine.

The method of any preceding clause, wherein the one or more grid events comprise one of a low-voltage ride through event (LVRT) or a zero-voltage ride through (ZVRT) event.

A power generating asset connected to an electrical grid, the power generating asset comprising: a generator; a power converter coupled to the generator; and a controller comprising at least one processor configured to perform a plurality of operations, the plurality of operations comprising: receiving an indication of one or more grid events occurring in the electrical grid; during recovery from the one or more grid events, implementing a power diverter function, the power diverter function comprising: computing an expected grid power from at least one of the grid power target and a grid power limit; computing a power deviation between a power associated with the drivetrain and an expected grid power; and diverting at least a portion of the power deviation to an energy buffer to prevent the portion of the power deviation from reaching the electrical grid.

The power generating asset of any preceding clause, further comprising receiving the grid power target associated with the operating power level before the one or more grid events from a sample and hold function.

The power generating asset of any preceding clause, wherein diverting at least the portion of the power deviation to the energy buffer further comprises: receiving, via the power diverter function, a plurality of inputs; determining, via the power diverter function, a power deviation using the plurality of inputs; and generating, via the power diverter function, an output based on the power deviation, the output comprising a power diverter command for the energy buffer.

The power generating asset of any preceding clause, wherein the plurality of inputs comprises at least one of a torque reference, a speed feedback signal, a power reference, a power reference signal from the power softening function, the grid power limit, a power offset signal, a torque feedback signal, a voltage magnitude signal, or combinations thereof.

The power generating asset of any preceding clause, wherein generating the output based on the power deviation further comprises: determining a power command signal associated only with the power deviation, and combining the power command signal associated only with the power deviation with a power offset signal to allow for positive and negative changes in energy buffer power around the power offset signal.

The power generating asset of any preceding clause, wherein the power diverter command for the energy buffer comprises the power offset signal and the power deviation, the power offset signal being triggered by the one or more grid events.

The power generating asset of any preceding clause, wherein the power diverter function further comprises adding the power diverter command for the energy buffer to an energy buffer power command of the energy buffer from the power softening function.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for controlling a power generating asset connected to an electrical grid, the power generating asset having a power converter and a drivetrain with, at least, a generator, the method comprising:
receiving, via a controller, a grid power target associated with an operating power level before one or more grid events occur in the electrical grid;
during recovery from the one or more grid events, implementing, via the controller, a power diverter function, the power diverter function comprising:
computing an expected grid power from at least one of the grid power target and a grid power limit;
computing a power deviation between a power associated with the drivetrain and an expected grid power; and
diverting at least a portion of the power deviation to an energy buffer to prevent the portion of the power deviation from reaching the electrical grid.

2. The method of claim 1, further comprising receiving the grid power target associated with the operating power level before the one or more grid events from a sample and hold function.

3. The method of claim 1, wherein diverting at least the portion of the power deviation to the energy buffer further comprises:
receiving, via the power diverter function, a plurality of inputs;
determining, via the power diverter function, the power deviation using the plurality of inputs; and
generating, via the power diverter function, an output based on the power deviation, the output comprising a power diverter command for the energy buffer.

4. The method of claim 3, wherein the plurality of inputs comprises at least one of a torque reference, a speed feedback signal, a power reference, a power reference signal from the power softening function, the grid power limit, a power offset signal, a torque feedback signal, a voltage magnitude signal, or combinations thereof.

5. The method of claim 6, further comprising determining a power command signal associated only with the power deviation.

6. The method of claim 5, wherein generating the output based on the power deviation further comprises:
combining the power command associated only with the power deviation with a power offset signal to allow for positive and negative changes in energy buffer power around the power offset signal.

7. The method of claim 6, wherein the power diverter command for the energy buffer comprises the power offset signal and the power deviation, the power offset signal being triggered by the one or more grid events.

8. The method of claim 7, wherein a magnitude of the power offset signal determines limits on the power command signal associated only with the power deviation.

9. The method of claim 3, wherein the power diverter function further comprises adding the power diverter command for the energy buffer to an energy buffer power command of the energy buffer from the power softening function.

10. The method of claim 9, wherein the power diverter function further comprises determining the energy buffer power command for the energy buffer as a function of a torque command and a torque reference of the generator.

11. The method of claim 9, wherein the power diverter function further comprises matching the energy buffer power command with an opposite sign of the power deviation to reduce or cancel the appearance of the power deviation in the grid power output.

12. The method of claim 1, wherein the power generating asset is a wind turbine.

13. The method of claim 1, wherein the one or more grid events comprise one of a low-voltage ride through event (LVRT) or a zero-voltage ride through (ZVRT) event.

14. A power generating asset connected to an electrical grid, the power generating asset comprising:
a generator;
a power converter coupled to the generator; and
a controller comprising at least one processor configured to perform a plurality of operations, the plurality of operations comprising:
receiving an indication of one or more grid events occurring in the electrical grid;
during recovery from the one or more grid events, implementing a power diverter function, the power diverter function comprising:
computing an expected grid power from at least one of the grid power target and a grid power limit;
computing a power deviation between a power associated with the drivetrain and an expected grid power; and
diverting at least a portion of the power deviation to an energy buffer to prevent the portion of the power deviation from reaching the electrical grid.

15. The power generating asset of claim 14, further comprising receiving the grid power target associated with the operating power level before the one or more grid events from a sample and hold function.

16. The power generating asset of claim 14, wherein diverting at least the portion of the power deviation to the energy buffer further comprises:
receiving, via the power diverter function, a plurality of inputs;
determining, via the power diverter function, a power deviation using the plurality of inputs; and
generating, via the power diverter function, an output based on the power deviation, the output comprising a power diverter command for the energy buffer.

17. The power generating asset of claim 16, wherein the plurality of inputs comprises at least one of a torque reference, a speed feedback signal, a power reference, a power reference signal from the power softening function, the grid power limit, a power offset signal, a torque feedback signal, a voltage magnitude signal, or combinations thereof.

18. The power generating asset of claim 16, wherein generating the output based on the power deviation further comprises:
determining a power command signal associated only with the power deviation; and
combining the power command signal associated only with the power deviation with a power offset signal to allow for positive and negative changes in energy buffer power around the power offset signal.

19. The power generating asset of claim 16, wherein the power diverter command for the energy buffer comprises the power offset signal and the power deviation, the power offset signal being triggered by the one or more grid events.

20. The power generating asset of claim 16, wherein the power diverter function further comprises adding the power diverter command for the energy buffer to an energy buffer power command of the energy buffer from the power softening function.
